(19) United States
(12) Patent Application Publication
(10) Pub. No.: US 2012/0016503 A1
(43) Pub. Date: Jan. 19, 2012

(54) METHOD AND APPARATUS FOR SWITCHING SIGNAL DELAY

(75) Inventors: Yue LANG, Munchen (DE); Wenhai WU, Beijing (CN); Lei MIAO, Beijing (CN); Zexin LIU, Beijing (CN); Chen HU, Shenzhen (CN); Qing ZHANG, Shenzhen (CN)

(73) Assignee: HUAWEI TECHNOLOGIES CO., LTD., Shenzhen (CN)

(21) Appl. No.: 13/243,444

(22) Filed: Sep. 23, 2011

Related U.S. Application Data
(63) Continuation of application No. PCT/CN2009/070975, filed on Mar. 24, 2009.

(51) Int. Cl. G06F 17/00

(52) U.S. Cl. 700/94

(57) ABSTRACT

A method for switching signal delay disclosed in the embodiments of the present invention includes: detecting a signal delay being currently transmitted; judging whether an adjacent delay transmitted successfully is equal to the signal delay being transmitted currently if it is detected that the signal delay being transmitted is switchable; and switching the signal delay being currently transmitted if it is determined that the adjacent delay transmitted successfully is not equal to the signal delay being transmitted currently. An apparatus for switching signal delay is also disclosed. The embodiments of the present invention are applicable to a scenario of switching delay of left-channel signals and right-channel signals.

### CROSS-REFERENCE TO RELATED APPLICATIONS

This application is a continuation of International Application No. PCT/CN2009/070975, filed on Mar. 24, 2009, which is hereby incorporated by reference in its entirety.

### FIELD OF THE INVENTION

The present invention relates to audio coding/decoding technologies, and in particular, to a method and an apparatus for switching signal delay.

### BACKGROUND OF THE INVENTION

In recent years, with development of computer technologies and digital signal processing technologies, people require high-definition television and audio systems and home audio-visual systems, and stereo technologies evolve rapidly, which imposes higher requirements on stereo technologies, especially coding and decoding technologies. A commonly used stereo coding method in the prior art is parametric stereo coding.

In the parametric stereo coding, the left-channel signals and the right-channel signals are mixed down, the mixed signals are encoded, and the extra sideband information is also encoded. On the decoder side, the stereo signals are recovered through the received mixed signals and sideband information. The sound-emitting object may change distance or have a distance difference relative to left and right microphones, as a result, the left-channel signals are not completely synchronous to the right-channel signals inevitably, and a delay exists between the left-channel signals and the right-channel signals. To synchronize the left-channel signals with the right-channel signals, the delay needs to be adjusted at the time of mixing down the left-channel signals and the right-channel signals, and the delay information needs to be transmitted to the decoder side.

In the prior art, delay information is composed of 8 bits, and the 8 bits are assigned to 4 continuous frames for sending, with each frame being equal to 2 bits. After 4 frames are output continuously, a 0 is inserted into the bit stream, and the inserted 0 in this position indicates that the delay information is transmitted to the decoder side successfully, and that the old delay needs to be switched to a new delay. Table 1 shows a bit stream structure of delay information.

TABLE 1

| frame(n − 1) | frame(n) | frame(n + 1) | frame(n + 2) | frame(n + 3) | frame(n + 4) |
|---|---|---|---|---|---|
| 0 (2 bits) | d (2 bits) | d (2 bits) | D (2 bits) | d (2 bits) | 0 (2 bits) |

As shown in Table 1, it takes 4 frames to transmit delay information to the decoder side completely, and delay is calculated out in every frame. When the delay information being transmitted differs from the delay calculated out in the current frame, a 0 is inserted into the current bit stream, and new delay information is transmitted in the next frame.

In the process of developing the present invention, the inventor finds at least the following problems in the prior art:

Because the delay switching is regardless of the position, the delay switching may be performed as long as the delay information being transmitted differs from the delay calculated out in the current frame. In this way, if the length of continuous nonzero frames transmitted before the delay switching is less than 4, the continuous nonzero frames are discarded as futile information on the decoder side. As a result, the discarded frames are changed into redundant data, and utilization ratio of bit streams is low.

### SUMMARY OF THE INVENTION

The embodiments of the present invention provide a method and an apparatus for switching signal delay to improve utilization ratio of bit streams.

Technical solutions provided in the embodiments of the present invention are as follows:

A method for switching signal delay, applied on a coder side, includes:

detecting a signal delay being currently transmitted;

judging whether an adjacent delay transmitted successfully is equal to the signal delay being transmitted currently if the signal delay being transmitted is detected to be switchable; and

switching the signal delay being currently transmitted if it is determined that the adjacent delay transmitted successfully is not equal to the signal delay being transmitted currently.

An apparatus for switching signal delay, includes:

a detecting unit, configured to detect a signal delay being currently transmitted;

a first judging unit, configured to judge whether an adjacent delay transmitted successfully is equal to the signal delay being transmitted currently if the detecting unit detects that the signal delay being transmitted is switchable; and

a delay switching unit, configured to switch the signal delay being currently transmitted if the first judging unit determines that the adjacent delay transmitted successfully is not equal to the signal delay being transmitted currently.

A method for switching signal delay, applied on a decoder side, includes:

reading delay information in a frame, and detecting the delay information;

judging whether an adjacent delay transmitted successfully is equal to the signal delay being transmitted currently if the delay information is detected as futile information; and

switching the signal delay being currently transmitted if determining that the adjacent delay transmitted successfully is not equal to the signal delay being transmitted currently.

An apparatus for switching signal delay, includes:

a detecting unit, configured to read delay information in a frame, and detect the delay information;

a first judging unit, configured to judge whether an adjacent delay transmitted successfully is equal to the signal delay being transmitted currently if the detecting unit detects the delay information as futile information; and

a delay switching unit, configured to switch the signal delay being currently transmitted if the first judging unit determines that the adjacent delay transmitted successfully is not equal to the signal delay being transmitted currently.

The method and the apparatus for switching signal delay are provided in the embodiments of the present invention. On the coder side, the apparatus detects whether the signal delay being transmitted currently is switchable; if the signal delay being transmitted currently is switchable, judges whether the adjacent delay transmitted successfully is equal to the delay being transmitted currently; and the apparatus switches the signal delay being currently transmitted if the adjacent delay transmitted successfully is not equal to the delay being transmitted currently. On the decoder side, the apparatus detects whether the read delay information is futile information; if the read delay information is futile information, judges whether the adjacent delay transmitted successfully is equal to the delay being transmitted currently; and the apparatus switches the signal delay being currently transmitted if the adjacent delay transmitted successfully is not equal to the delay being transmitted currently. Compared with the prior art, the embodiments of the present invention make the delay switching position more flexible, and make sure that delay switching information may be transmitted successfully to the decoder, thus improving the utilization ratio of bit streams.

### BRIEF DESCRIPTION OF THE DRAWINGS

To make the technical solutions of the present invention or the prior art clearer, the following outlines the accompanying drawings involved in the description of the embodiments of the present invention or the prior art. Apparently, the accompanying drawings outlined below are illustrative rather than exhaustive, and persons of ordinary skill in the art can derive other drawings from them without any creative effort.

FIG. 1 is a flowchart of a method for switching signal delay, applied on a coder side, according to a first embodiment of the present invention;

FIG. 2 is a flowchart of a method for switching signal delay, applied on a coder side, according to a second embodiment of the present invention;

FIG. 3 is a flowchart of a method for switching signal delay, applied on a decoder side, according to a third embodiment of the present invention;

FIG. 4 is a flowchart of a method for switching signal delay, applied on a decoder side, according to a fourth embodiment of the present invention;

FIG. 5 is a schematic structure diagram of an apparatus for switching signal delay, applied on a coder side, according to a fifth embodiment of the present invention;

FIG. 6 is a schematic structure diagram of an apparatus for switching signal delay, applied on a coder side, according to a sixth embodiment of the present invention;

FIG. 7 is a schematic structure diagram of an apparatus for switching signal delay, applied on a decoder side, according to a seventh embodiment of the present invention; and

FIG. 8 is a schematic structure diagram of an apparatus for switching signal delay, applied on a decoder side, according to an eighth embodiment of the present invention.

### DETAILED DESCRIPTION OF THE EMBODIMENTS

The technical solutions of the present invention will become apparent from the following and more particular description of the exemplary and other embodiments of the invention, as illustrated in the accompanying drawings. Evidently, the described embodiments are merely part of rather than all embodiments. All other embodiments, which can be derived by those skilled in the art from the embodiments given herein without any creative effort, shall fall within the scope of the present invention.

To make the merits of the technical solution of the present invention clearer, the embodiments of the present invention are described in detail with reference to accompanying drawings.

In all embodiments of the present invention, delay information is transmitted through N frames, and each frame carries the same number of bits, where N is an integer greater than or equal to 1.

### Embodiment 1

This embodiment provides a method for switching signal delay to improve the utilization ratio of bit streams.

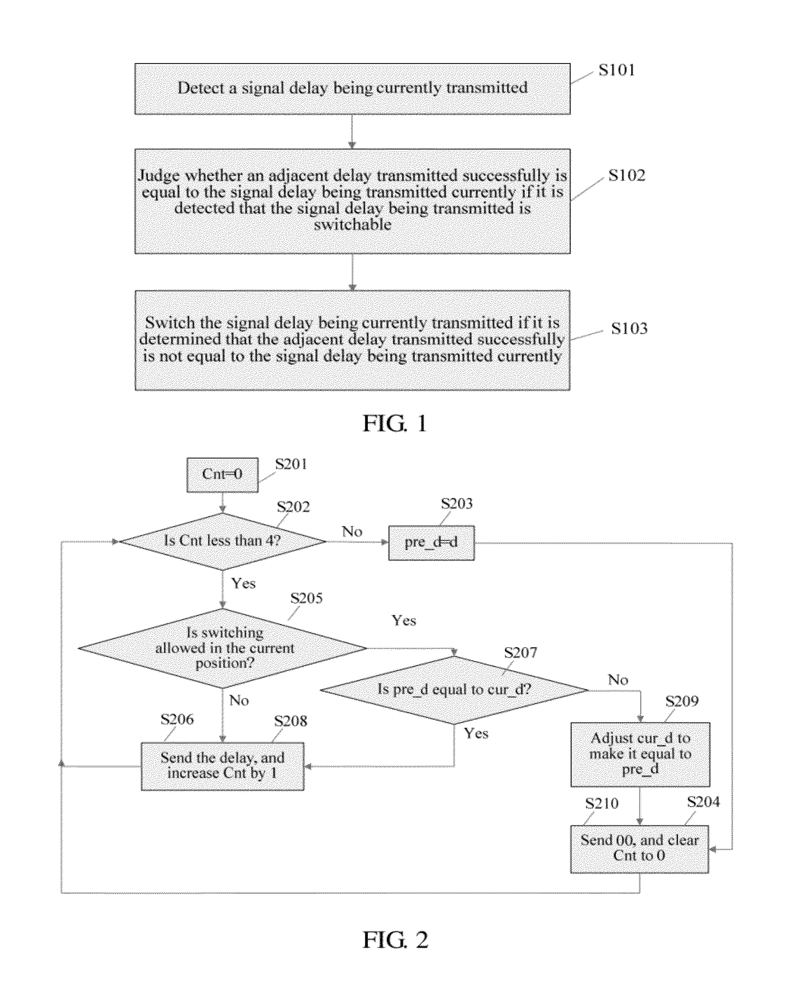

As shown in FIG. 1, the method for switching signal delay, applied on a coder side, includes the following steps:

S101. Detect a signal delay being currently transmitted.

S102. Judge whether an adjacent delay transmitted successfully is equal to the signal delay being transmitted currently if it is detected the signal delay being transmitted is switchable.

S103. Switch the signal delay being currently transmitted if it is determined that the adjacent delay transmitted successfully is not equal to the signal delay being transmitted currently.

The method for switching signal delay, applied on the coder side, is provided in the embodiment of the present invention, including: detecting whether the signal delay being transmitted currently is switchable; if the signal delay being transmitted currently is switchable, judging whether the adjacent delay transmitted successfully is equal to the delay being transmitted currently; and switching the signal delay being currently transmitted if the adjacent delay transmitted successfully is not equal to the delay being transmitted currently. Compared with the prior art, the method in this embodiment of the present invention makes the delay switching position more flexible, and makes sure that delay switching information is transmitted successfully to the decoder, thus improving the utilization ratio of bit streams.

### Embodiment 2

In this embodiment, delay information is composed of 8 bits, and the 8 bits are assigned to 4 continuous frames, with each frame being equal to 2 bits. After 4 continuous nonzero frames are output, a 0 is inserted into the bit stream.

As shown in FIG. 2, the method for switching signal delay, applied on a coder side, includes the following steps:

S201. Count frames which are continuously transmitted.

S202. Judge whether the number (Cnt) of continuously transmitted frames is less than 4.

S203. If the number (Cnt) of continuously transmitted frames is not less than 4, namely, the Cnt is equal to 4, update the value of the previous delay (pre_d) successfully transmitted to the value of the delay (d) that is composed of the continuous 4 frames and is transmitted successfully.

S204. Insert a 0 after the frame being currently transmitted, clear the counter, and return to step S202.

S205. If the number (Cnt) of continuously transmitted frames is less than 4, judge whether the delay is switchable.

S206. If the delay is not switchable, continue to transmit the delay, increase the number (Cnt) of continuously transmitted frames by 1, and return to step S202.

S207. If the delay is switchable, judge whether previous delay (pre_d) which is successfully transmitted is equal to the latest delay (cur_d) which is adopted for adjusting the left-channel signals and the right-channel signals.

S208. If previous delay (pre_d) which is successfully transmitted is equal to cur_d which is adopted for adjusting the left-channel signals and the right-channel signals, continue to transmit the delay, increase the number (Cnt) of continuously transmitted frames by 1, and return to step S202.

S209. If previous delay (pre_d) which is successfully transmitted is not equal to cur_d which is adopted for adjusting the left-channel signals and the right-channel signals, adjust cur_d which is adopted for adjusting the left-channel signals and the right-channel signals to make it equal to previous delay (pre_d) which is successfully transmitted.

S210. Insert a 0 after the frame being currently transmitted, clear the counter, and return to step S202.

The method for switching signal delay provided in this embodiment makes the position of delay switching more flexible, and makes sure the delay switching information is successfully transmitted to the decoder, thus improving the utilization ratio of bit streams.

### Embodiment 3

This embodiment provides a method for switching signal delay to improve the utilization ratio of bit streams.

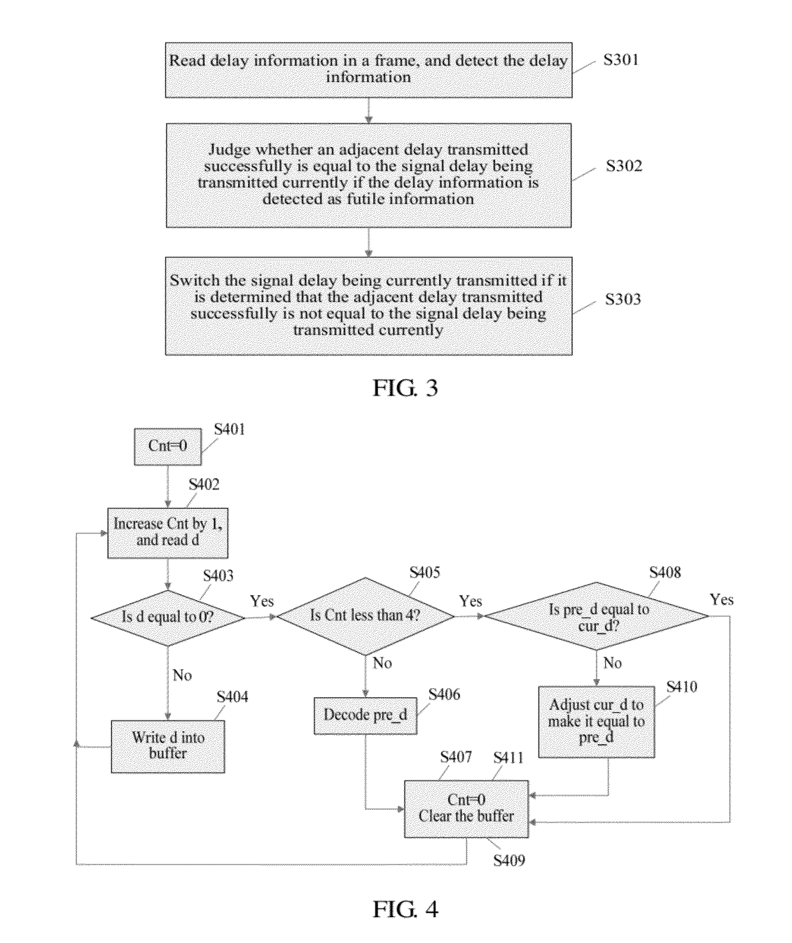

As shown in FIG. 3, the method for switching signal delay, applied on a decoder side, includes the following steps:

S301. Read delay information in a frame, and detect the delay information.

S302. Judge whether an adjacent delay transmitted successfully is equal to the signal delay being transmitted currently if the delay information is detected as futile information.

S303. Switch the signal delay being currently transmitted if it is determined that the adjacent delay transmitted successfully is not equal to the signal delay being transmitted currently.

The method for switching signal delay, applied on the decoder side, is provided by the embodiment of the present invention, including: detecting whether the read delay information is futile information; if the read delay information is futile information, judging whether the adjacent delay transmitted successfully is equal to the delay being transmitted currently; and switching the signal delay being currently transmitted if the adjacent delay transmitted successfully is not equal to the delay being transmitted currently. Compared with the prior art, the method in this embodiment makes the delay switching position more flexible, and makes sure that delay switching information may be successfully received and decoded, thus improving the utilization ratio of bit streams.

### Embodiment 4

In this embodiment, corresponding to the method applied on the coder side in the third embodiment, delay information is composed of 8 bits, and the 8 bits are assigned to 4 continuous frames, with each frame being equal to 2 bits. After 4 continuous nonzero frames are received, the 4 continuous nonzero frames are decoded, and the nonzero frames in the buffer are purged.

As shown in FIG. 4, the method for switching signal delay, applied on a decoder side, includes the following steps:

S401. Count received frames that are continuously transmitted.

S402. Increase, by the counter, the number of the received frames, which are continuously transmitted, by 1, and read the delay (d) in the currently received frame, where d is a 2-bit delay read in the bit stream.

S403. Judge whether the delay (d) is 0.

S404. If the delay (d) is not 0, write the delay (d) into the buffer, and return to step S402.

S405. If the delay (d) is 0, judge whether the number (Cnt) of continuously transmitted frames is less than 4.

S406. Decode the previous delay (pre_d) that is successfully received if the number (Cnt) of continuously transmitted frames is not less than 4, namely, the Cnt is equal to 4.

S407. Clear the counter, purge the buffer, and return to step S402.

S408. If the number (Cnt) of continuously transmitted frames is less than 4, judge whether the previous delay (pre_d) transmitted successfully is equal to the latest delay (cur_d) that is adopted for adjusting the left-channel signals and the right-channel signals.

S409. If the previous delay (pre_d) transmitted successfully is equal to cur_d that is adopted for adjusting the left-channel signals and the right-channel signals, clear the counter, purge the buffer, and return to step S402.

S410. If the previous delay (pre_d) transmitted successfully is not equal to cur_d that is adopted for adjusting the left-channel signals and the right-channel signals, adjust cur-_d that is adopted for adjusting the left-channel signals and the right-channel signals to make it equal to the previous delay (pre_d) successfully transmitted.

S411. Clear the counter, purge the buffer, and return to step S402.

The method for switching signal delay provided in this embodiment makes the position of delay switching more flexible, and makes sure that the delay switching information is successfully received and decoded, thus improving the utilization ratio of bit streams.

### Embodiment 5

This embodiment provides an apparatus for switching signal delay to improve the utilization ratio of bit streams.

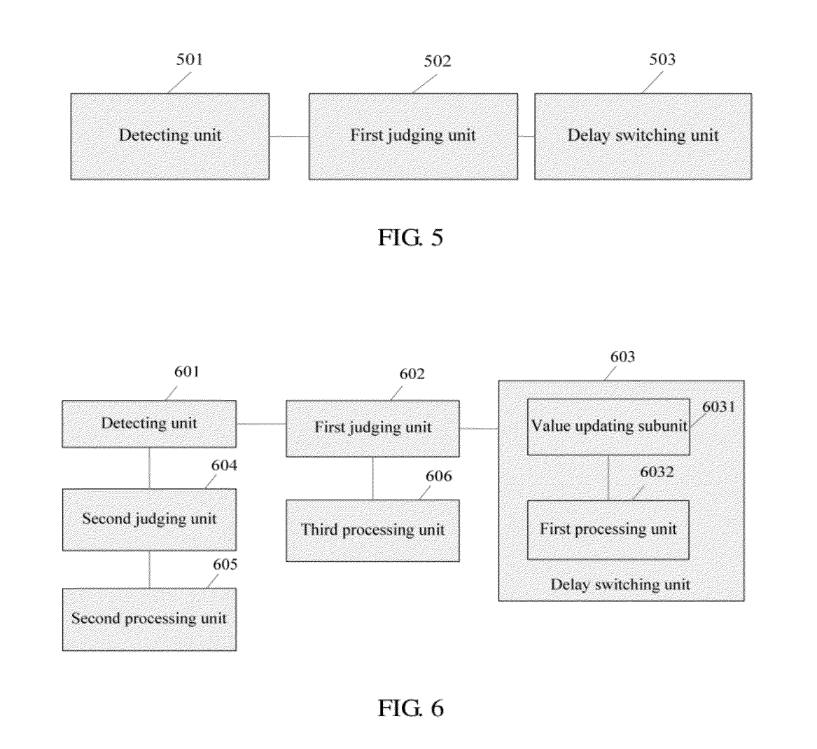

As shown in FIG. 5, the apparatus for switching signal delay, applied on a coder side, includes:

a detecting unit 501, configured to detect a signal delay being currently transmitted;

a first judging unit 502, configured to judge whether an adjacent delay transmitted successfully is equal to the signal delay being transmitted currently if the detecting unit 501 detects that the signal delay being transmitted is switchable; and

a delay switching unit 503, configured to switch the signal delay being currently transmitted if the first judging unit 502 determines that the adjacent delay transmitted successfully is not equal to the signal delay being transmitted currently.

The apparatus for switching signal delay, applied on the coder side, detects whether the signal delay being transmitted currently is switchable, and, if the signal delay being transmitted currently is switchable, judges whether the adjacent delay transmitted successfully is equal to the delay being transmitted currently; the apparatus switches the signal delay being currently transmitted if the adjacent delay transmitted successfully is not equal to the delay being transmitted currently. Compared with the prior art, the apparatus in this embodiment makes the delay switching position more flexible, and makes sure that delay switching information may be successfully transmitted to the decoder, thus improving the utilization ratio of bit streams.

### Embodiment 6

As shown in FIG. 6, the apparatus for switching signal delay, applied on a coder side, includes:

a detecting unit 601, configured to detect a signal delay being currently transmitted;

a first judging unit 602, configured to judge whether an adjacent delay transmitted successfully is equal to the signal delay being transmitted currently if the detecting unit 601 detects that the signal delay being transmitted is switchable; and

a delay switching unit 603, configured to switch the signal delay being currently transmitted if the first judging unit 602 determines that the adjacent delay transmitted successfully is not equal to the signal delay being transmitted currently.

The delay switching unit 603 includes:

a value updating subunit 6031, configured to update the value of the adjacent delay transmitted successfully to the value of the delay being currently transmitted; and

a first processing subunit 6032, configured to continue to transmit the next signal delay.

The apparatus further includes:

a second judging unit 604, configured to judge whether the signal delay being transmitted currently is transmitted successfully.

The apparatus further includes:

a second processing unit 605, configured to: update the value of the adjacent delay transmitted successfully to the value of the current delay successfully transmitted, and continue to transmit the next signal delay, if the second judging unit 604 determines that the current signal delay is transmitted successfully.

The apparatus further includes:

a third processing unit 606, configured to continue to transmit the signal delay being currently transmitted if the first judging unit 602 determines that the adjacent delay transmitted successfully is equal to the signal delay being transmitted currently.

The apparatus for switching signal delay provided in this embodiment makes the position of delay switching more flexible, and makes sure that the delay switching information may be successfully transmitted to the decoder, thus improving the utilization ratio of bit streams.

### Embodiment 7

This embodiment provides a delay switching apparatus to improve the utilization ratio of bit streams.

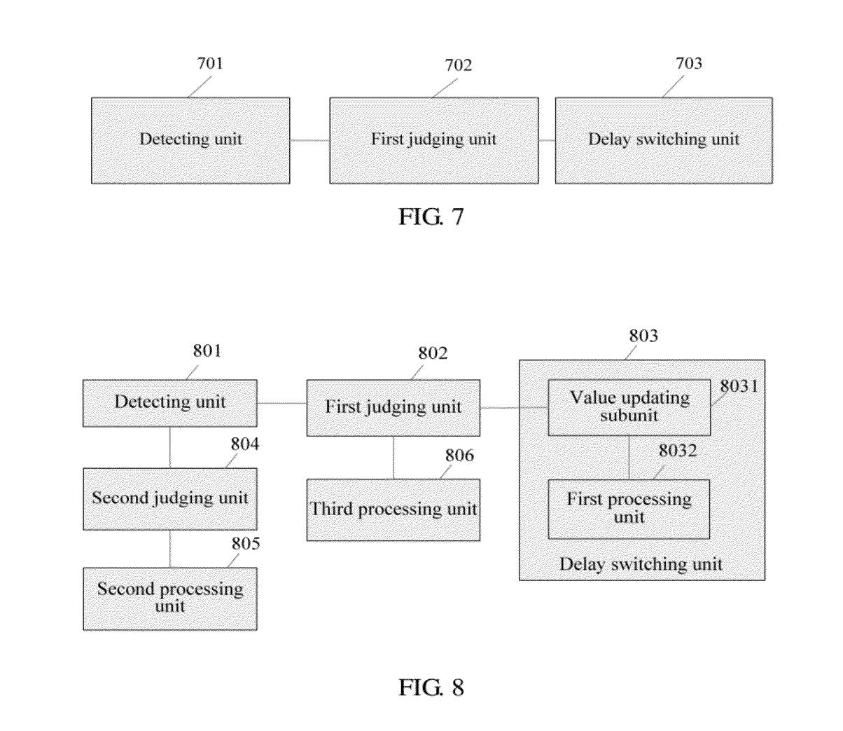

As shown in FIG. 7, the apparatus for switching signal delay, applied on a decoder side, includes:

a detecting unit 701, configured to read delay information in a frame, and detect the delay information;

a first judging unit 702, configured to judge whether an adjacent delay transmitted successfully is equal to the signal delay being transmitted currently if the detecting unit 701 detects the delay information as futile information; and

a delay switching unit 703, configured to switch the signal delay being currently transmitted if the first judging unit 702 determines that the adjacent delay transmitted successfully is not equal to the signal delay being transmitted currently.

The apparatus for switching signal delay, applied on the decoder side, detects whether the read delay information is futile information, and, if the read delay information is futile information, judges whether the adjacent delay transmitted successfully is equal to the delay being transmitted currently; the apparatus switches the signal delay being currently transmitted if the adjacent delay transmitted successfully is not equal to the delay being transmitted currently. Compared with the prior art, the apparatus in this embodiment makes the delay switching position more flexible, and makes sure that delay switching information may be successfully received and decoded, thus improving the utilization ratio of bit streams.

### Embodiment 8

As shown in FIG. 8, the apparatus for switching signal delay, applied on a decoder side, includes:

a detecting unit 801, configured to read delay information in a frame, and detect the delay information;

a first judging unit 802, configured to judge whether an adjacent delay transmitted successfully is equal to the signal delay being transmitted currently if the detecting unit 801 detects the delay information as futile information; and

a delay switching unit 803, configured to switch the signal delay being currently transmitted if the first judging unit 802 determines that the adjacent delay transmitted successfully is not equal to the signal delay being transmitted currently.

The delay switching unit 803 includes:

a value updating subunit 8031, configured to update the value of the adjacent delay successfully transmitted to the value of the delay being currently transmitted; and

a first processing subunit 8032, configured to purge the buffer and continue to read delay information in a next frame.

The apparatus further includes:

a second judging unit 804, configured to judge whether the signal delay being transmitted currently is transmitted successfully.

The apparatus further includes:

a second processing unit 805, configured to: decode the current signal delay, purge the buffer and read delay information in a next frame if the second judging unit 804 determines that the current signal delay is transmitted successfully.

The apparatus further includes:

a third processing unit 806, configured to purge the buffer and read delay information in a next frame if the first judging unit 802 determines that the adjacent delay transmitted successfully is equal to the signal delay being transmitted currently.

The apparatus for switching signal delay provided in this embodiment makes the position of delay switching more flexible, and makes sure that the delay switching information is successfully received and decoded, thus improving the utilization ratio of bit streams.

Persons of ordinary skill in the art should understand that all or part of the steps of the method provided in the embodiments mentioned above may be implemented by a program instructing relevant hardware, where the program may be stored in computer readable storage media. When the program runs, the program may execute the steps of the method specified in any embodiment above. The storage media may be magnetic disk, Compact Disk Read-Only Memory (CD-ROM), Read-Only Memory (ROM), Random Access Memory (RAM).

The above descriptions are merely exemplary embodiments of the present invention, but not intended to limit the protection scope of the present invention. Any modifications, variations or replacement that can be easily derived by those skilled in the art shall fall within the protection scope of the present invention. Therefore, the protection scope of the present invention is subject to the appended claims.

What is claimed is:

1. A method for switching signal delay applied on a coder side, comprising:
detecting a signal delay being currently transmitted;
judging whether an adjacent delay transmitted successfully is equal to the signal delay being transmitted currently if it is detected that the signal delay being transmitted is switchable; and
switching the signal delay being currently transmitted if it is determined that the adjacent delay transmitted successfully is not equal to the signal delay being transmitted currently.

2. The method for switching signal delay according to claim 1, wherein the switching the signal delay being currently transmitted if it is determined that the adjacent delay transmitted successfully is not equal to the signal delay being transmitted currently comprises:
updating value of the adjacent delay successfully transmitted to the value of the delay being currently transmitted; and
continuing to transmit a next signal delay.

3. The method for switching signal delay according to claim 1, wherein, before detecting the signal delay being currently transmitted, the method further comprises:
judging whether the signal delay being currently transmitted is transmitted successfully, wherein
a result of the judgment is that the signal delay being transmitted currently is not transmitted successfully.

4. The method for switching signal delay according to claim 3, wherein, after judging whether the signal delay being transmitted currently is transmitted successfully, the method further comprises:
updating value of the adjacent delay successfully transmitted to the value of the current signal delay being successfully transmitted, and continuing to transmit a next signal delay if a result of the judgment is that the signal delay being transmitted currently is transmitted successfully.

5. The method for switching signal delay according to claim 1, wherein, after judging whether the adjacent delay transmitted successfully is equal to the signal delay being transmitted currently, the method further comprises:
continuing to transmit the signal delay being currently transmitted if it is determined that the adjacent delay transmitted successfully is equal to the signal delay being transmitted currently.

6. A method for switching signal delay applied on a decoder side, comprising:
reading delay information in a frame, and detecting the delay information;
judging whether an adjacent delay transmitted successfully is equal to the signal delay being transmitted currently if the delay information is detected as futile information; and
switching the signal delay being currently transmitted if it is determined that the adjacent delay transmitted successfully is not equal to the signal delay being transmitted currently.

7. The method for switching signal delay according to claim 6, wherein switching the signal delay being currently transmitted if it is determined that the adjacent delay transmitted successfully is not equal to the signal delay being transmitted currently comprises:
updating value of the adjacent delay successfully transmitted to the value of the delay being currently transmitted; and
purging a buffer, and continuing to read delay information in a next frame.

8. The method for switching signal delay according to claim 6, wherein, before judging whether the adjacent delay transmitted successfully is equal to the signal delay being transmitted currently, the method further comprises:
judging whether the signal delay being transmitted currently is transmitted successfully, wherein
a result of the judgment is that the signal delay being transmitted currently is not transmitted successfully.

9. The method for switching signal delay according to claim 8, wherein, after judging whether the signal delay being transmitted currently is transmitted successfully, the method further comprises:
decoding the current signal delay, purging the buffer and reading delay information in a next frame if a result of the judgment is that the current signal delay is transmitted successfully.

10. The method for switching signal delay according to claim 6, wherein, after judging whether the adjacent delay transmitted successfully is equal to the signal delay being transmitted currently, the method further comprises:
purging the buffer and reading delay information in a next frame if it is determined that the adjacent delay transmitted successfully is equal to the signal delay being transmitted currently.

11. An apparatus for switching signal delay, comprising:
a detecting unit, configured to detect a signal delay being currently transmitted;
a first judging unit, configured to judge whether an adjacent delay transmitted successfully is equal to the signal delay being transmitted currently if the detecting unit detects that the signal delay being transmitted is switchable; and
a delay switching unit, configured to switch the signal delay being currently transmitted if the first judging unit determines that the adjacent delay transmitted successfully is not equal to the signal delay being transmitted currently.

12. The apparatus for switching signal delay according to claim 11, wherein the delay switching unit comprises:
a value updating subunit, configured to update value of the adjacent delay successfully transmitted to the value of the delay being currently transmitted; and
a first processing subunit, configured to continue to transmit a next signal delay.

13. The apparatus for switching signal delay according to claim 11, further comprising:
a second judging unit, configured to judge whether the signal delay being transmitted currently is transmitted successfully.

14. The apparatus for switching signal delay according to claim 13, further comprising:
a second processing unit, configured to: update value of the adjacent delay transmitted successfully to the value of the current delay successfully transmitted, and continue to transmit a next signal delay, if the second judging unit determines that the current signal delay is transmitted successfully.

15. The apparatus for switching signal delay according to claim 11, further comprising:
a third processing unit, configured to continue to transmit the signal delay being currently transmitted if the first judging unit determines that the adjacent delay transmitted successfully is equal to the signal delay being transmitted currently.

16. An apparatus for switching signal delay, comprising:
a detecting unit, configured to read delay information in a frame, and detect the delay information;
a first judging unit, configured to judge whether an adjacent delay transmitted successfully is equal to the signal delay being transmitted currently if the detecting unit detects the delay information as futile information; and
a delay switching unit, configured to switch the signal delay being currently transmitted if the first judging unit determines that the adjacent delay transmitted successfully is not equal to the signal delay being transmitted currently.

17. The apparatus for switching signal delay according to claim 16, wherein the delay switching unit comprises:
a value updating subunit, configured to update value of the adjacent delay successfully transmitted to the value of the delay being currently transmitted; and
a first processing subunit, configured to purge a buffer and continue to read delay information in a next frame.

18. The apparatus for switching signal delay according to claim 16, further comprising:
a second judging unit, configured to judge whether the signal delay being transmitted currently is transmitted successfully.

19. The apparatus for switching signal delay according to claim 18, further comprising:
a second processing unit, configured to: decode the current signal delay, purge the buffer and read delay information in a next frame if the second judging unit determines that the current signal delay is transmitted successfully.

20. The apparatus for switching signal delay according to claim 16, further comprising:
a third processing unit, configured to purge the buffer and read delay information in the next frame if the first judging unit determines that the adjacent delay transmitted successfully is equal to the signal delay being transmitted currently.
